(19) United States
(12) Patent Application Publication
(10) Pub. No.: US 2005/0033814 A1
(43) Pub. Date: Feb. 10, 2005

(54) Communication terminal apparatus and processing method for sending and receiving email

(76) Inventor: Naomi Ota, Nagoya (JP)

Correspondence Address: WENDEROTH, LIND & PONACK, L.L.P., 2033 K STREET N. W., SUITE 800, WASHINGTON, DC, 20006-1021, US

(21) Appl. No.: 10/895,311

(22) Filed: Jul. 21, 2004

(30) Foreign Application Priority Data
Aug. 4, 2003 (JP) 2003-286147

(51) Int. Cl. G06F 15/16

(52) U.S. Cl. 709/206; 709/207

(57) ABSTRACT

A communication terminal apparatus and a processing method for sending and receiving email are provided, with which even if a sender's apparatus sends an email which uses character codes not supported by a receiver's apparatus, the receiver's apparatus can display the content of the email without displaying unintelligible characters. If a created email contains undisplayable character codes which are unreproducible on the receiver side, a sender's communication terminal apparatus 1 creates a file regarding font information associated with the undisplayable character codes, and then sends the email with the created file attached thereto. If a received email has an attached file regarding font information, a receiver's communication terminal apparatus 7 expands the file to obtain the font information, reproduces undisplayable character codes by referring to the obtained font information, and then reproduces the content of the email.

### BACKGROUND OF THE INVENTION

1. Field of the Invention

The present invention relates to a communication terminal apparatus and a processing method for sending and receiving email, and in particular to a processing method for sending email and a processing method for receiving email in a communication terminal apparatus, such as a mobile phone, which has built-in email functions (which include carrier's original email functions).

2. Description of the Background Art

In recent years, the use of communication terminal apparatuses, such as mobile phones and PDAs, which have built-in email functions has rapidly increased. As is known, there exist a plurality of telecommunications carriers (hereinafter referred to as “carriers”) and equipment makers (hereinafter referred to as “makers”) for communication terminal apparatuses. Each individual carrier or maker is trying to distinguish itself from other carriers or makers by providing the user with emoticons, special characters, etc., which are originally designed for email. Communication terminal apparatuses of a same type can be used in a plurality of Western countries. However, as most of the western countries use their own languages, communication terminal apparatuses are often required to support various languages. Due to these circumstances, in the case where email is sent and received between communication terminal apparatuses (e.g., mobile phones) of different carriers or makers, the following problems occur.

First, in the case where a sender's mobile phone sends to a receiver's mobile phone an email containing emoticons, special characters, etc., which are not supported by the receiver's mobile phone, i.e., an email using character codes which are not supported by the receiver's mobile phone, the receiver's mobile phone is unable to reproduce the character codes, which are consequently displayed as unintelligible characters. Even if the receiver's mobile phone has font information associated with such character codes, the sender's intended nuance may not be conveyed properly to the receiver because font information associated with a given character code may vary from carrier to carrier, maker to maker, or mobile phone to mobile phone.

The font information is used to convert a character code into a format displayable on an output unit such as a display. Typically, the font information is in a tabulated form in which each character code is associated with its corresponding content (e.g., bitmap data or vector data) to be displayed on the screen.

The above-described problems can be solved if the communication terminal apparatus has font information associated with various character codes. However, mobile phones in actual use, available storage capacity is limited and storing a large amount of font information is not feasible.

For decoration of characters and the like, there is a technique proposed in Japanese Laid-Open Patent Publication No. 11-31112, for example. According to the publication, a sender extracts information other than information about characters, i.e., information about character decoration, from a created text and converts the information into a file. Then, the sender sends a text file with the converted file attached thereto by email. The receiver automatically identifies the file attached to the email and overlays the character decoration information on specified characters in the text file. In this manner, the conventional technique makes it possible to send and receive characters together with their decoration information by email. FIG. 10 is a diagram for explaining processing for sending and receiving email according to the conventional technique.

The technique described in the publication, however, relates to a technique for sending and receiving character decoration information in email, and does not relate to a method of preventing unintelligible characters from being displayed when email is sent and received between mobile phones of different carriers or makers.

Further, the technique described in the publication requires special processes, i.e., the process of converting by the sender a portion of character decoration in a text file into an attached file based on a predetermined format, and the process of overlaying by the receiver the text file and the attached file (character decoration information). The processing load of these processes is heavy for limited-throughput mobile phones, etc.

### SUMMARY OF THE INVENTION

Therefore, an object of the present invention is to provide a communication terminal apparatus and a processing method for sending and receiving email which are capable of displaying, even if a sender's apparatus has sent an email which uses character codes not supported by a receiver's apparatus, the content of the email without causing the processing load of the apparatus to increase and without displaying unintelligible characters on the receiver's apparatus.

A first aspect of the present invention is directed to a communication terminal apparatus having built-in email functions. To attain the object mentioned above, a communication terminal apparatus which acts as a sender of email according to the present invention comprises a determination section as a basic component, and further comprises a storage section, a file creation section, and a sending section as additional components. The determination section, storage section, file creation section, and sending section may be configured in a relay station for relaying an email sent from the communication terminal apparatus.

The determination section determines among character codes used in an email whether there is a character code whose display content needs to be sent to a receiver's apparatus. The storage section stores font information in which character codes to be used in an email are associated with their corresponding contents to be displayed on a screen. The file creation section creates a file regarding font information about the character code determined in the determination section. The sending section sends the email with the file created in the file creation section attached thereto.

Typically, the determination section determines an undisplayable character code which is unreproducible on the receiver's apparatus, as a character code whose display content needs to be sent to the receiver's apparatus. The determination may be made based on information about undisplayable character codes provided by the receiver's apparatus, or may be made based on at least one selected from the group consisting of a carrier, maker, and model of the receiver's apparatus. The carrier may be identified by one of a phone number and a domain of an email address of the receiver's apparatus. It is preferred that a character code whose font information has previously been sent be excluded from undisplayable character codes which are unreproducible on the receiver's apparatus.

Information about the carrier, maker, and model of the receiver's apparatus maybe obtained from an exchange server which relays email transmission/reception. If the exchange server has font information in which character codes to be used in an email are associated with their corresponding contents to be displayed on the screen, the exchange server can create a file regarding font information about the character codes determined in the determination section of the sender's apparatus.

It is preferred that information about displayable character codes which are reproducible on the receiver's apparatus be held in advance in the sender's apparatus. It is desirable that the information about displayable character codes be held for each address of an address book or for each font group. It is also possible to inquire, before sending the email, the receiver's apparatus about whether the email contains any undisplayable character codes. It is convenient to store the inquiry results in an address book as information. A character code specified by a user may be determined as a character code whose display content needs to be sent to the receiver's apparatus.

A communication terminal apparatus which acts as a receiver of email according to the present invention comprises a receiving section, a determination section, an expansion section, a storage section, and a processing section.

The receiving section receives an email. The determination section determines whether the email received by the receiving section has an attached file regarding font information in which character codes used in the email are associated with their corresponding contents to be displayed on a screen. The expansion section expands, if the determination section determines that the email has an attached file regarding font information, the file regarding font information. The storage section stores the font information obtained through the expansion process by the expansion section. The processing section reproduces character codes used in the email received by the receiving section, by referring to the font information stored in the storage section.

If a plurality of pieces of font information are present for a single character code, each piece of font information is assigned with a priority level for screen display and stored in the storage section, or each piece of font information is stored in the storage section so as to be associated with one of a sender and an email. In the former case, the processing section may select a piece of font information to be used for reproduction, in accordance with the priority levels. For example, font information which has been attached as a file to an email is assigned with the highest priority level when the email is displayed. The priority level of the font information may also be assigned by a user. In the latter case, the processing section may select a piece of font information to be used for reproduction, in accordance with a sender who has sent the email or with an email.

If a plurality of pieces of font information are present for a single character code, the processing section may use a first piece of retrieved font information to reproduce the character code, or may present a user with the plurality of pieces of font information so that the user can select one from the plurality of pieces of font information. Even in the former case, it is favorable to notify a user that the character code is reproducible even using font information other than the first piece of retrieved font information.

It is preferred that the determination section determine whether a file attached to the email is a font information file by a file name extension thereof. In the case where predetermined information indicating that font information is present is embedded in a body or header of the email by a sender's apparatus, the determination may be made by the predetermined information. Alternatively, the determination may be directly made by checking whether a body of the email contains any undisplayable character codes.

If the processing section cannot reproduce all of the character codes used in the email even by referring to the font information stored in the storage section, it is preferred that the processing section request a communication terminal apparatus which has sent the email to send further font information. In addition, in the case where the receiver's apparatus acts to send email, the receiver's apparatus may create an email based on a user's input, using the font information stored in the storage section.

If the storage section does not have sufficient storage for storing additional font information obtained through the expansion process by the expansion section, it is preferred that one or more pieces of currently stored font information be deleted. The currently stored font information to be deleted may be determined based on at least one property thereof selected from the group consisting of a frequency of being referred to, a date of last reference, and a storage date, and possibly by user's instruction.

It is preferred that the font information stored in the storage section be deleted at the same time as all emails associated with the font information are deleted, or at the same time as an email having the font information attached thereto is deleted.

The processes performed by individual components of the above-described communication terminal apparatus can be taken as a processing method for sending email and a processing method for receiving email which provide a series of processing steps. These methods can be provided in the form of a program for causing a computer to perform a series of processing steps. The program may be installed on a computer through a computer-readable storage medium having stored thereon the program.

As described above, according to the present invention, the sender can send an email with font information about specific character codes attached thereto, so that the sender can convey the right nuance to the receiver. By allowing the receiver to set specific character codes as undisplayable character codes, the receiver can reproduce email content without displaying unintelligible characters. In addition, by allowing the sender to receive character codes undisplayable on the receiver from the receiver, the determination as to whether there is a character code whose font information needs to be sent to the receiver can be made properly and quickly.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a configuration of a sender's communication terminal apparatus 1 according to an embodiment of the present invention;

FIG. 2 is a flowchart showing the flow of processing for sending email performed by the sender's communication terminal apparatus 1 according to the embodiment of the present invention;

FIGS. 3A to 3C are diagrams showing examples of a method of associating a receiver's communication terminal apparatus 7 with font information;

FIG. 4 is a block diagram illustrating a configuration of a mail server which manages font information;

FIG. 5 is a diagram showing an exemplary email text created by a sender;

FIG. 6A is a diagram showing exemplary font information stored in a font information storage section 12;

FIG. 6B is an exemplary file created by a font information file creating section 15;

FIG. 7 is a block diagram illustrating a configuration of a receiver's communication terminal apparatus 7 according to an embodiment of the present invention;

FIG. 8 is a flowchart showing the flow of processing for receiving email performed by the receiver's communication terminal apparatus 7 according to the embodiment of the present invention;

FIG. 9 is a sequence diagram showing the flow of a request to send further font information performed by the communication terminal apparatuses 1 and 7; and

FIG. 10 is a diagram for explaining processing for sending and receiving email according to a conventional technique.

### DESCRIPTION OF THE PREFERRED EMBODIMENTS

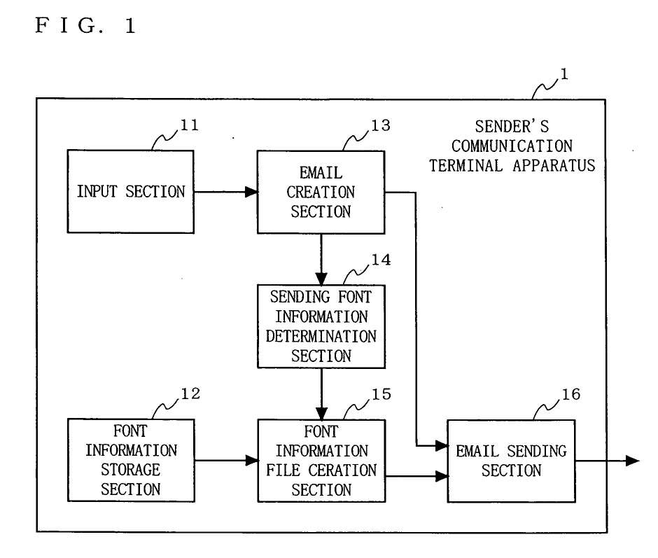

With reference to FIGS. 1 to 9, an embodiment of the present invention will be described below.

(1) Configuration of a Sender's Apparatus

FIG. 1 is a block diagram illustrating a configuration of a communication terminal apparatus 1 according to an embodiment of the present invention in the case of acting as a sender's apparatus. In FIG. 1, the sender's communication terminal apparatus 1 includes an input section 11 which is a user interface; a font information storage section 12 which is a storage section; an email creation section 13 which is a processing section; a sending font information determination section 14; a font information file creation section 15; and an email sending section 16 which is a communication interface.

First, a general description of each component of the sender's communication terminal apparatus 1 will be provided.

The content of an email created by a user is inputted to the email creation section 13 through the input section 11. The font information storage section 12 stores font information about character codes usable in the communication terminal apparatus 1. The email creation section 13 creates an email based on the content of the email inputted from the input section 11. The sending font information determination section 14 receives the email created in the email creation section 13 and determines whether there is font information to be sent to a receiver's communication terminal apparatus 7 (described later) Specifically, the sending font information determination section 14 determines whether the created email uses any characters which display unintelligible characters when displayed on the receiver's communication terminal apparatus 7.

Base on the determination result by the sending font information determination section 14, the font information file creation section 15 obtains font information to be sent to the receiver's communication terminal apparatus 7, from the font information storage section 12 and creates a predetermined file. The email sending section 16 inputs the email created in the email creation section 13 and the file created in the font information file creation section 15, and sends the email with the file attached thereto to the receiver's communication terminal apparatus 7.

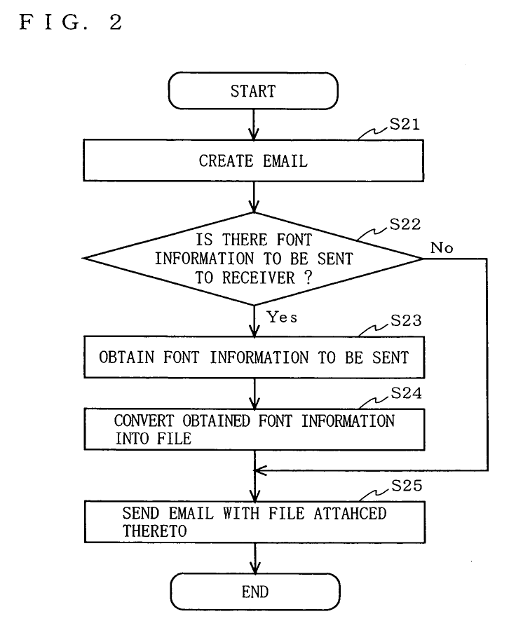

Now, with further reference to FIG. 2, a processing method for sending email performed by the sender's communication terminal apparatus 1 configured in the manner described above will be described. FIG. 2 is a flowchart showing the flow of processing for sending email performed by the sender's communication terminal apparatus 1 according to the embodiment of the present invention.

The email creation section 13 creates an email based on the content of an email created by a user (step S21). Once the email is created, the sending font information determination section 14 determines whether there is font information to be sent to the receiver's communication terminal apparatus 7, by checking whether the email contains any undisplayable character codes (step S22). Typically, the undisplayable character codes include character codes for which font information is specially needs to be obtained so that the receiver's communication terminal apparatus 7 can properly reproduce (display on the screen) such character codes; and character codes whose font information is different between the sender and the receiver. In other words, the undisplayable character codes are character codes corresponding to emoticons, special characters, etc., which are originally set on the sender's communication terminal apparatus 1.

Typically, the determination by the sending font information determination section 14 is performed automatically or manually based on font information about character codes which are displayable (or undisplayable) on the receiver's communication terminal apparatus 7. This font information may be held in advance or may be obtained upon creation of an email. In addition, the font information may be information each associated with a single character code or a font group (e.g., Japanese, Russian, italic, an emoticon of xx company, etc.).

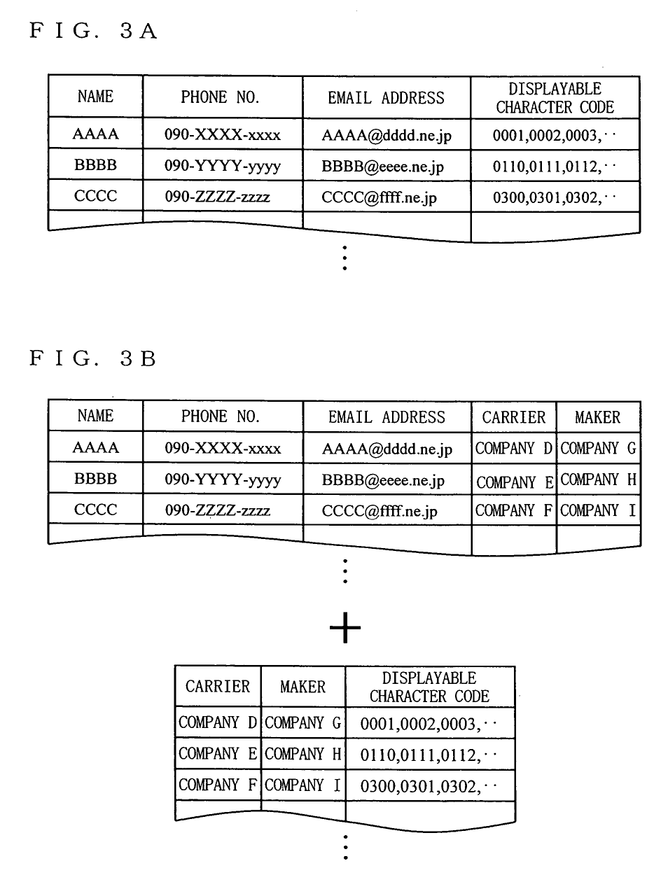

As a specific example, in the case where the font information is obtained and held in advance, the font information may be obtained such that by using a database such as an address book, displayable font information is associated with each address (see FIG. 3A). Alternatively, the font information may be created such that displayable font information is associated with each carrier, maker, or model (see FIGS. 3B and 3C). Information used to determine a carrier, maker, and model of each receiver may be stored in advance in a database, such as an address book, as personal information. The carrier may be identified by a telephone number or the domain of an email address.

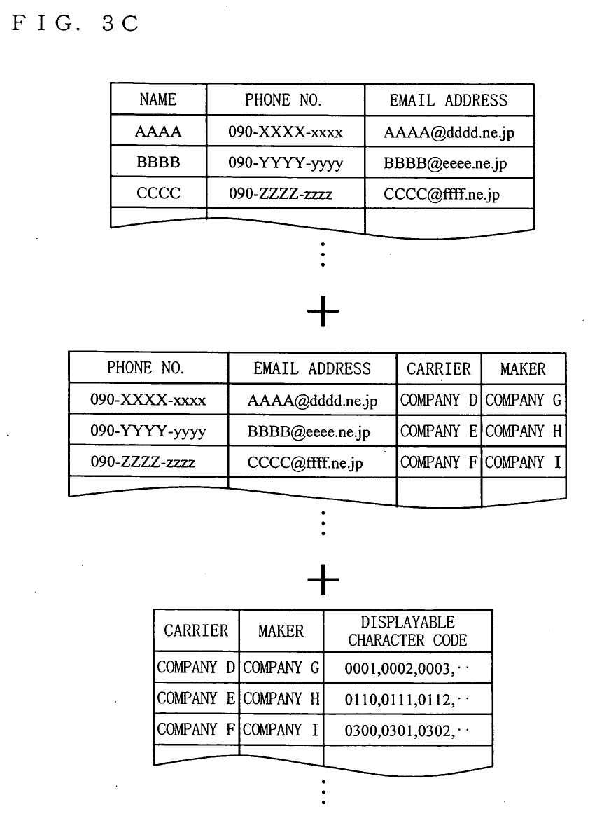

As a specific example, in the case where the font information is obtained upon creation of an email, the font information may be obtained by inquiring, before sending an email, the sender's exchange server, mail server, or the like which holds the above-described font information. In this case, the sender's communication terminal apparatus 1 may inquire the exchange server, mail server, or the like only about whether character codes are displayable, or may allow the exchange server, mail server, or the like to attach font information about undisplayable character codes to an email (see FIG. 4). Alternatively, the sender's communication terminal apparatus 1 may directly inquire the receiver's communication terminal apparatus 7. The inquiry results may be stored in a database such as an address book.

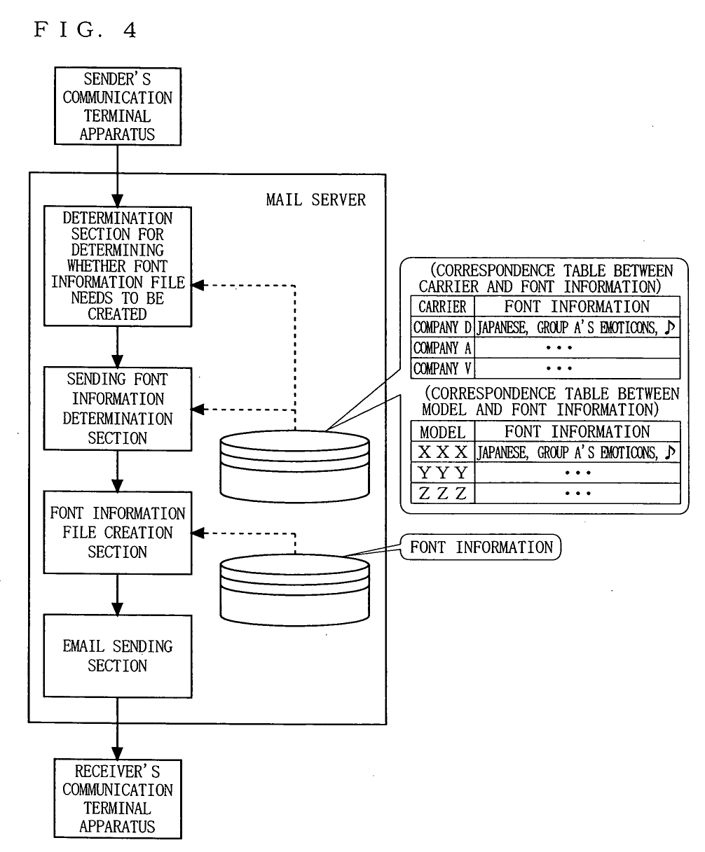

For example, if the symbol “ [symbol] ” (character code: 0002) and the symbol “⋆” (character code: 0004) in a text shown in FIG. 5 are not supported by the receiver's communication terminal apparatus 7, the sending font information determination section 14 determines the character codes of the symbols as undisplayable character codes.

If the sending font information determination 14 determines that the email contains undisplayable character codes (step 22, Yes), the font information file creation section 15 obtains font information about the undisplayable character codes from the font information storage section 12 (step S23). The font information file creation section 15 then converts the obtained font information into a file (step S24). In the case where there are a plurality of pieces of font information, a single file in which the plurality of pieces of font information are compiled may be created, or a plurality of files corresponding to the plurality of pieces of font information may be created. If font information about an undisplayable character code has previously been sent to the receiver, such font information may be excluded from the font information file.

The email sending section 16 sends to the receiver's communication terminal apparatus 7 the email created in the email creation section 13 with the file created in the font information file creation section 15 attached thereto (step S25).

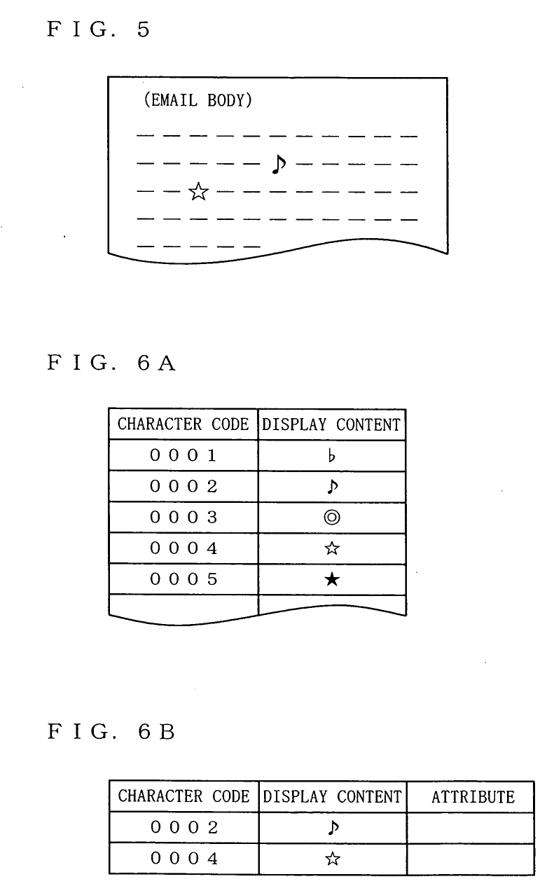

For example, the font information storage section 12 prestores font information usable in the sender's communication terminal apparatus 1, in which individual character codes are associated with their corresponding contents to be displayed on the screen, as shown in FIG. 6A. Specifically, in the case of the text shown in FIG. 5, the font information file creation section 15 obtains font information about the character codes 0002 and 0004 which are determined as undisplayable, from the font information storage section 12. The font information file creation section 15 then creates a font information file only for the undisplayable character codes, as shown in FIG. 6B. Note that in the attribute field in FIG. 6B, information such as the data format of a display content (e.g., bitmap data, vector data, etc.) is stored, if necessary.

(2) Configuration of a Receiver's Apparatus

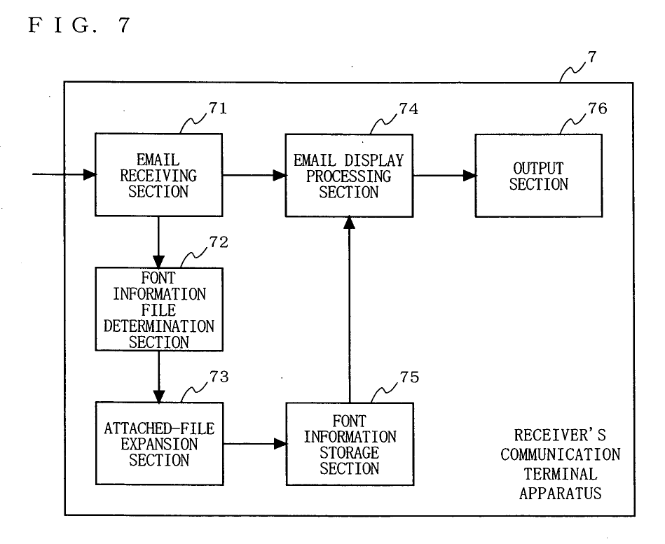

FIG. 7 is a block diagram illustrating a configuration of a communication terminal apparatus 7 according to an embodiment of the present invention in the case of acting as a receiver's apparatus. In FIG. 7, the receiver's communication terminal apparatus 7 includes an email receiving section 71 which is a communication interface; a font information file determination section 72 which is a processing section; an attached-file expansion section 73, an email display processing section 74; a font information storage section 75 which is a storage section; and an output section 76 which is a user interface.

First, a general description of each component of the receiver's communication terminal apparatus 7 will be provided.

An email sent from a sender's communication terminal apparatus 1 is received by the email receiving section 71. The font information file determination section 72 determines whether the email received by the email receiving section 71 has an attached file regarding font information. Based on the determination by the font information file determination section 72, the attached-file expansion section 73 expands a file regarding font information attached to the email to the font information storage section 75. The font information storage section 75 stores the font information obtained through the file expansion. The email display processing section 74 reproduces the content of the email received by the email receiving section 71 by referring to the font information stored in the font information storage section 75, and outputs the reproduced email content to the output section 76.

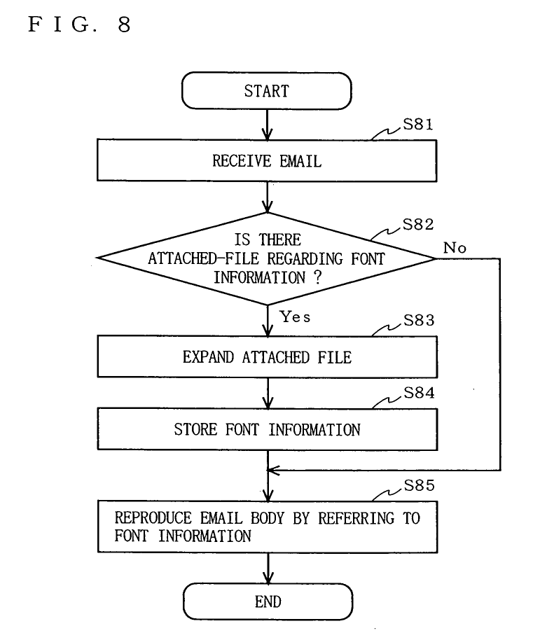

Now, with further reference to FIG. 8, a processing method for receiving email performed by the receiver's communication terminal apparatus 7 configured in the manner described above will be described. FIG. 8 is a flowchart showing the flow of processing for receiving email performed by the receiver's communication terminal apparatus 7 according to the embodiment of the present invention.

An email sent from the sender's communication terminal apparatus 1 is received by the email receiving section 71 (step S81). When the email is received, the font information file determination section 72 determines whether the email has an attached file regarding font information (step S82). As described above, the file regarding font information is obtained in such a manner that font information associated with character codes which are undisplayable on the sender's communication terminal apparatus 1 is converted into a file. To determine whether the email has an attached file regarding font information, for example, the following methods may be employed.

A first method is as follows. A unique file name extension is appended to a font information file in advance. The receiver's communication terminal apparatus 7 makes a determination by the file name extension of a file attached to the email.

A second method is as follows. The sender's communication terminal apparatus 1 embeds predetermined information indicating that font information is present, in the email body, particularly in the header. The receiver's communication terminal apparatus 7 makes a determination by checking whether the email has the predetermined information embedded in the email body or the header.

A third method is as follows. The receiver's communication terminal apparatus 7 itself directly determines whether there are any character codes which are undisplayable in the email body.

If the font information file determination section 72 determines that the email has an attached file regarding font information (step S82, Yes), the attached-file expansion section 73 expands the attached file (step S83). The attached-file expansion section 73 then stores the font information about undisplayable character codes obtained through the expansion, in the font information storage section 75 (see step S84 and FIG. 6B). The email display processing section 74 properly reproduces the undisplayable character codes by referring to the font information stored in the font information storage section 75, and then outputs the email content to the output section 76 (step S85).

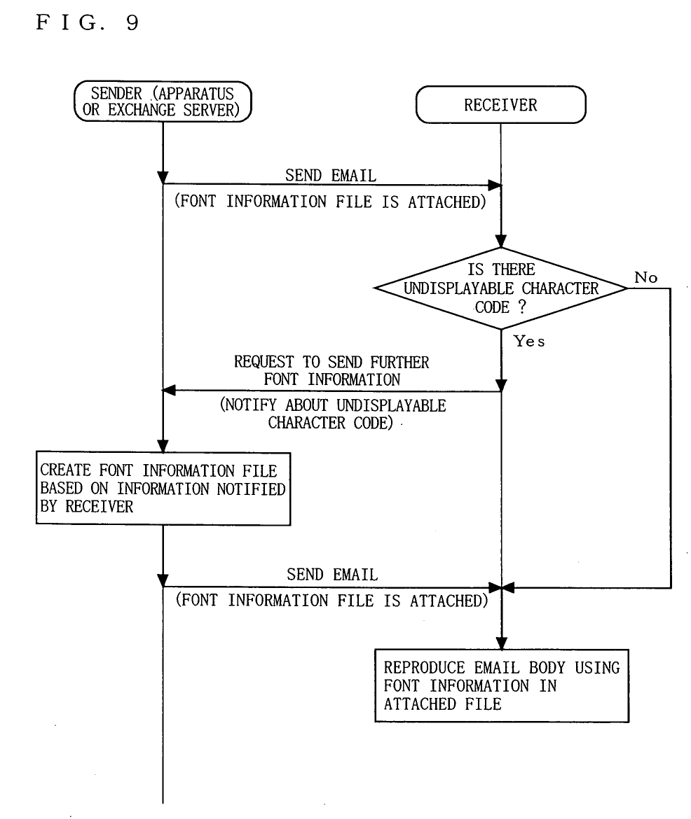

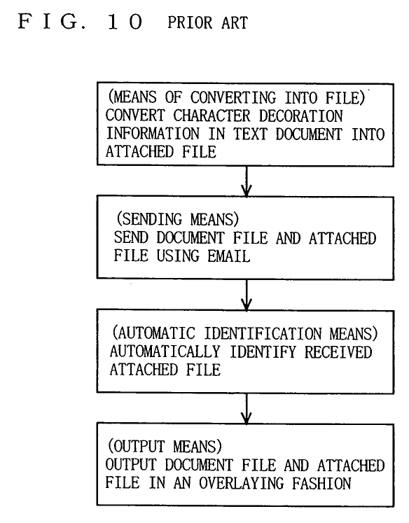

If information about the receiver's apparatus, etc., held by the sender's communication terminal apparatus 1 is not up-to-date, the body of an email may not be reproduced using only font information based on the not-up-to-date information which is attached to the email. In such a case, the receiver's communication terminal apparatus 7 requests the sender's communication terminal apparatus 1 (or the exchange server or mail server) to send further font information. FIG. 9 is a sequence diagram showing the flow of the request to send further font information.

The above-described embodiment describes the case where the font information is extracted through expansion of an attached file, however, the present invention is not limited thereto. For example, if there is a method available which allows the communication terminal apparatus to refer to font information without expanding an attached file, the communication terminal apparatus of the present invention may employ such a method.

In the case where the font information storage section 75 has a limited storage capacity and cannot continue to store additional font information obtained from the attached file of the email at step S84, one or more pieces of font information which are currently stored in the font information storage section 75 may be deleted. For example, font information may be deleted automatically by the communication terminal apparatus or manually by the receiver's instruction, based on properties such as a high frequency of being referred to for display and a recent storage date. For example, font information to be deleted may be one with a low frequency of being referred to, one whose stored date is not up-to-date, one whose last reference date is not recent, etc. Alternatively, at the same time as an email is deleted, font information contained in a file attached to the email may be deleted. In the case where a plurality of emails are associated with a piece of font information, the piece of font information may be deleted at the same time as all the associated emails are deleted. Of course, the user can specify which font information to delete or retain.

The receiver's communication terminal apparatus 7 normally stores basic font information associated with usable character codes, in a storage section other than the font information storage section 75. Thus, upon reproduction of an email, the email display processing section 74 first needs to refer to this storage section to obtain font information about general character codes and then further refers to the font information storage section 75 to obtain font information about undisplayable character codes. Hence, by storing basic font information in the font information storage section 75 in advance, the email display processing section 74 only needs, upon reproduction of an email, to refer to the font information storage section 75, which results in simplification of the process.

In the case where the font information storage section 75 stores a plurality of pieces of font information associated with a single character code, the email display processing section 74 may selectively obtain one of the plurality of pieces of font information. Typically, the selection is made as follows. A predetermined priority level is assigned to each piece of font information so that a selection is made automatically in accordance with the priority levels. The priority level may be set such that the highest priority level is assigned to font information contained in a file attached to an email, for example. Alternatively, the sender's communication terminal apparatus 1 may assign a priority level to font information in advance. By thus assigning the priority levels, email content can be reproduced with optimum efficiency.

Alternatively, the selection may be made as follows. Each piece of font information is stored in the font information storage section 75 so as to be associated with each sender or each email so that a selection is automatically made in accordance with a sender who has sent an email. In addition, font information may be selected such that a plurality of pieces of selectable font information are presented to a receiver so that the receiver specifies one from the presented font information. Further, a first piece of retrieved font information (default) maybe selected. In this case, pieces of usable font information other than the default may be presented to the user so that the user can make a selection from the notified font information.

In the case where the receiver's communication terminal apparatus 7 acts as the sender of email, the communication terminal apparatus 7 may create an email using the font information about undisplayable character codes stored in the font information storage section 75. For example, in the case where the communication terminal apparatus 7 creates an email addressed to a destination communication terminal apparatus which had previously sent to the communication terminal apparatus 7 font information about undisplayable character codes, the communication terminal apparatus 7 may create an email body using the character codes having been sent from the destination apparatus and stored in the font information storage section 75, rather than using it's own character codes. This allows the communication terminal apparatus to use the character codes displayable on the destination apparatus already at the time of creation of an email body, and therefore it becomes unnecessary to attach font information to the email body. Accordingly, the communication resource can be effectively utilized.

As described above, according to the communication terminal apparatus and the processing method for sending and receiving email of the embodiment of the present invention, the sender sends an email with font information about undisplayable character codes attached thereto. Therefore, even if the receiver receives an email using undisplayable character codes, the receiver can reproduce the email content without displaying unintelligible characters; as a result, the sender can convey the right nuance to the receiver.

Further, in the case of a communication terminal apparatus with a limited storage capacity (e.g., mobile phone terminals), only necessary font information is provided, and thus it is possible to suppress the consumption of the storage capacity of the receiver's communication terminal apparatus 7. In addition, the process of converting font information into an attached file and the process of expanding an attached file are simple, and thus even if a communication terminal apparatus with limited throughput capacity can reproduce with a small processing load an email which uses undisplayable character codes.

The above-described embodiment describes a method in which the receiver's communication terminal apparatus 7 obtains font information about undisplayable character codes from a file attached in the sender's communication terminal apparatus 1. In addition to this method, the font information about undisplayable character codes may be obtained such that the receiver's communication terminal apparatus 7 downloads font information from an exchange server, mail server, etc., on the network, for example.

While the invention has been described in detail, the foregoing description is in all aspects illustrative and not restrictive. It is understood that numerous other modifications and variations can be devised without departing from the scope of the invention.

1. A communication terminal apparatus having built-in email functions, comprising:
a determination section for determining among character codes used in an email whether there is a character code whose display content needs to be sent to a receiver's apparatus.

2. The communication terminal apparatus according to claim 1, further comprising:
a storage section for storing font information in which character codes to be used in an email are associated with their corresponding contents to be displayed on a screen;
a file creation section for creating a file regarding font information about the character code determined in the determination section; and
a sending section for sending the email with the file created in the file creation section attached thereto.

3. The communication terminal apparatus according to claim 1, wherein the determination section determines an undisplayable character code which is unreproducible on the receiver's apparatus, as a character code whose display content needs to be sent to the receiver's apparatus.

4. The communication terminal apparatus according to claim 3, wherein the determination section makes a determination based on information about undisplayable character codes provided by the receiver's apparatus.

5. The communication terminal apparatus according to claim 3, wherein the undisplayable character code is determined based on at least one selected from the group consisting of a carrier, maker, and model of the receiver's apparatus.

6. The communication terminal apparatus according to claim 5, wherein the carrier is identified by one of a phone number and a domain of an email address of the receiver's apparatus.

7. The communication terminal apparatus according to claim 5, wherein information about the carrier, maker, and model of the receiver's apparatus is obtained from an exchange server which relays email transmission/reception.

8. The communication terminal apparatus according to claim 2, wherein the determination section excludes a character code whose font information has previously been sent, from undisplayable character codes which are unreproducible on the receiver's apparatus.

9. The communication terminal apparatus according to claim 3, wherein information about displayable character codes which are reproducible on the receiver's apparatus is held in advance.

10. The communication terminal apparatus according to claim 9, wherein the information about displayable character codes is held for each address of an address book.

11. The communication terminal apparatus according to claim 10, wherein the information about displayable character codes is held for each font group.

12. The communication terminal apparatus according to claim 4, wherein the determination section inquires, before sending the email, the receiver's apparatus about whether the email contains any undisplayable character codes.

13. The communication terminal apparatus according to claim 12, wherein the determination section stores the inquiry results in an address book as information.

14. The communication terminal apparatus according to claim 1, wherein the determination section determines a character code specified by a user as a character code whose display content needs to be sent to the receiver's apparatus.

15. A communication terminal apparatus having built-in email functions, comprising:
a receiving section for receiving an email;
a determination section for determining whether the email received by the receiving section has an attached file regarding font information in which character codes used in the email are associated with their corresponding contents to be displayed on a screen;
an expansion section for expanding, if the determination section determines that the email has an attached file, the file regarding font information;
a storage section for storing the font information obtained through the expansion process by the expansion section; and
a processing section for reproducing character codes used in the email received by the receiving section, by referring to the font information stored in the storage section.

16. The communication terminal apparatus according to claim 15, wherein
if a plurality of pieces of font information are present for a single character code, each piece of font information is assigned with a priority level for screen display and stored in the storage section, and
the processing section selects a piece of font information to be used for reproduction, in accordance with the priority levels.

17. The communication terminal apparatus according to claim 15, wherein
if a plurality of pieces of font information are present for a single character code, each piece of font information is stored in the storage section so as to be associated with one of a sender and an email, and
the processing section selects a piece of font information to be used for reproduction, in accordance with a sender who has sent the email or with an email.

18. The communication terminal apparatus according to claim 15, wherein if a plurality of pieces of font information are present for a single character code, the processing section uses a first piece of retrieved font information to reproduce the character code.

19. The communication terminal apparatus according to claim 15, wherein if a plurality of pieces of font information are present for a single character code, the processing section presents a user with the plurality of pieces of font information so that the user can select one from the plurality of pieces of font information.

20. The communication terminal apparatus according to claim 18, wherein the processing section notifies a user that the character code is reproducible even using font information other than the first piece of retrieved font information.

21. The communication terminal apparatus according to claim 15, wherein the determination section determines whether a file attached to the email is a font information file by a file name extension thereof.

22. The communication terminal apparatus according to claim 15, wherein the determination section determines whether a file attached to the email is a font information file by predetermined information which is embedded in a body or header of the email and which indicates that font information is present.

23. The communication terminal apparatus according to claim 15, wherein the determination section determines whether a file attached to the email is a font information file by checking whether a body of the email contains any undisplayable character codes.

24. The communication terminal apparatus according to claim 15, wherein if the processing section cannot reproduce all of the character codes used in the email even by referring to the font information stored in the storage section, the processing section requests a communication terminal apparatus which has sent the email to send further font information.

25. The communication terminal apparatus according to claim 15, further comprising an email creation section for creating an email based on a user's input, using the font information stored in the storage section.

26. The communication terminal apparatus according to claim 16, wherein font information which has been attached as a file to an email is assigned with the highest priority level when the email is displayed.

27. The communication terminal apparatus according to claim 16, wherein the priority level of the font information is assigned by a user.

28. The communication terminal apparatus according to claim 15, wherein if the storage section does not have sufficient storage for storing additional font information obtained through the expansion process by the expansion section, the storage section deletes one or more pieces of currently stored font information.

29. The communication terminal apparatus according to claim 28, wherein the currently stored font information to be deleted is determined based on at least one property thereof selected from the group consisting of a frequency of being referred to, a date of last reference, and a storage date.

30. The communication terminal apparatus according to claim 28, wherein the currently stored font information to be deleted is determined by user's instruction.

31. The communication terminal apparatus according to claim 15, wherein the font information stored in the storage section is deleted at the same time as all emails associated with the font information are deleted.

32. The communication terminal apparatus according to claim 15, wherein the font information stored in the storage section is deleted at the same time as an email having the font information attached thereto is deleted.

33. A relay station for relaying an email sent from a communication terminal apparatus, comprising:
a determination section for determining among character codes used in an email whether there is a character code whose display content needs to be sent to a receiver's apparatus;
a storage section for storing font information in which character codes to be used in an email are associated with their corresponding contents to be displayed on a screen;
a file creation section for creating a file regarding font information about the character code determined in the determination section; and
a sending section for sending the email with the file created in the file creation section attached thereto.

34. The relay station according to claim 33, wherein the determination section determines an undisplayable character code which is unreproducible on the receiver's apparatus, as a character code whose display content needs to be sent to the receiver's apparatus.

35. The relay station according to claim 33, wherein the determination section makes a determination based on information about undisplayable character codes provided by the receiver's apparatus.

36. The relay station according to claim 33, wherein the undisplayable character code is determined based on at least one selected from the group consisting of a carrier, maker, and model of the receiver's apparatus.

37. The relay station according to claim 36, wherein the carrier is identified by one of a phone number and a domain of an email address of the receiver's apparatus.

38. The relay station according to claim 36, wherein information about the carrier, maker, and model of the receiver's apparatus is obtained from the communication terminal apparatus which has sent the email.

39. A processing method for sending email performed by a communication terminal apparatus having built-in email functions, comprising the steps of:
creating an email based on a user's input;
determining among character codes used in the created email whether there is a character code whose display content needs to be sent to a receiver's apparatus;
creating a file regarding font information about the determined character code, the font information in which character codes to be used in an email are associated with their corresponding contents to be displayed on a screen; and
sending the created email with the created file attached thereto.

40. A processing method for receiving email performed by a communication terminal apparatus having built-in email functions, comprising the steps of:
receiving an email;
determining whether the received email has an attached file regarding font information in which character codes used in the email are associated with their corresponding contents to be displayed on a screen;
if it is determined that the received email has an attached file regarding font information, expanding the file regarding font information; and
reproducing character codes used in the received email, by referring to the font information obtained at the expansion step.

41. A program for causing a communication terminal apparatus having built-in email functions to perform a processing method for sending email, the program comprising the steps of:
creating an email based on a user's input;
determining among character codes used in the created email whether there is a character code whose display content needs to be sent to a receiver's apparatus;
creating a file regarding font information about the determined character code, the font information in which character codes to be used in an email are associated with their corresponding contents to be displayed on a screen; and
sending the created email with the created file attached thereto.

42. A program for causing a communication terminal apparatus having built-in email functions to perform a processing method for receiving email, the program comprising the steps of:
receiving an email;
determining whether the received email has an attached file regarding font information in which character codes used in the email are associated with their corresponding contents to be displayed on a screen;
if it is determined that the received email has an attached file regarding font information, expanding the file regarding font information; and
reproducing character codes used in the received email, by referring to the font information obtained at the expansion step.

43. A computer-readable storage medium which stores a program for causing a communication terminal apparatus having built-in email functions to perform a processing method for sending email, the program comprising the steps of:
creating an email based on a user's input;
determining among character codes used in the created email whether there is a character code whose display content needs to be sent to a receiver's apparatus;
creating a file regarding font information about the determined character code, the font information in which character codes to be used in an email are associated with their corresponding contents to be displayed on a screen; and
sending the created email with the created file attached thereto.

44. A computer-readable storage medium which stores a program for causing a communication terminal apparatus having built-in email functions to perform a processing method for receiving email, the program comprising the steps of:
receiving an email;
determining whether the received email has an attached file regarding font information in which character codes used in the email are associated with their corresponding contents to be displayed on a screen;
if it is determined that the received email has an attached file regarding font information, expanding the file regarding font information; and
reproducing character codes used in the received email, by referring to the font information obtained at the expansion step.
